(19) United States
(12) Patent Application Publication
(10) Pub. No.: US 2005/0171302 A1
(43) Pub. Date: Aug. 4, 2005

(54) Coating composition for tendon for prestressed concrete

(76) Inventors: Seiichiro Hirata, Amagasaki-shi (JP); Shoji Shirahama, Amagasaki-shi (JP); Toshio Kobayashi, Sodegaura-shi (JP); Ichirou Aoyama, Yokohama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/514,039

(22) PCT Filed: May 9, 2003
(86) PCT No.: PCT/JP03/05810

(30) Foreign Application Priority Data
May 13, 2002 (JP) 2002-137736
Dec. 9, 2002 (JP) 2002-357247

(51) Int. Cl. C08L 63/00

(52) U.S. Cl. 525/528

(57) ABSTRACT

Disclosed is a coating composition for PC tendon, which is applied on surface of the PC tendon. This composition includes epoxy resin, multifunctional isocyanate compound, calcium oxide and water, and further includes water-absorbing polymer as necessary. A curing time thereof is adjusted so that tensioning by the PC tendon can be exerted 30 days or later after casting of the concrete. Accordingly, even when applied to a massive concrete structure, the coating composition enables effective tensioning after hardening of the concrete, while exhibiting excellent storage stability.

### TECHNICAL FIELD

The present invention relates to a coating composition applied on a surface of PC (Prestressed Concrete) steel product or the like used as tendon in post-tensioning system of prestressed concrete for the purpose of preventing rust and corrosion as well as integrating the tendon with the concrete.

### BACKGROUND ART

Concrete used in various constructions has a disadvantage of vulnerability to tension force. In order to compensate for this disadvantage, there has been known concrete provided with improved tension strength by preliminarily applied compression force with PC tendon. This concrete is called as prestressed concrete. As a representative method of producing such prestressed concrete, post-tensioning system has been known.

A general production method of prestressed concrete by this post-tensioning system is described below. Before casting of concrete, sheath member is disposed in the concrete. Then, PC tendon (PC steel wire, PC steel twist wire, PC hard steel wire, PC steel rod, continuous fiber, or the like) is inserted into the sheath member. After hardening of the concrete, the PC tendon is tensioned by means of a tensioning machine. After that, in order to prevent the PC tendon from rusting and becoming eroded as well as to achieve adhesion and integration of the PC tendon with the concrete, cement milk or the like is injected between the sheath member and the PC tendon.

However, according to this method, the operations of inserting the PC tendon into the sheath member and injecting the cement milk or the like are very complicated. As the result, this method requires great time and labor, leading a drawback of cost rise. In addition, since the space between the inserted PC tendon and the sheath member is very narrow, and the PC tendon is arranged in a curved manner, it is difficult to completely fill the whole of the sheath member with the cement milk or the like, so that the tendon may be corroded in the defectively filled region.

In order to solve the above problems, there have been proposed methods of preliminarily coating the surfaces of tendon with coating material (see, for example, Japanese Examined Patent Publication No. HEI 3-28551 (1991), Japanese Examined Patent Publication No. SHO 53-47609 (1978) and the like). These methods can be generally classified into (1) those giving anti-rust and anti-corrosion effects and (2) those improving adhesion between concrete and the tendon while giving anti-rust and anti-corrosion effects.

In a typical example of methods (1), epoxy resin as coating material is electrostatic-coated on the surface of PC steel material as tendon. Although anti-rust and anti-corrosion effects can be exerted by this method, the coating material is brought into a completely cured state on the surface of the tendon. Therefore, when this method is used in a post-tensioning system, insertion of the tendon into sheath member and grouting operation for integrating the concrete and the tendon are still required as is the case of usual post-tensioning system, so that the problem of cost rise remains unsolved.

On the other hand, one exemplary method of the above classification (2) uses so-called unbonding PC steel material obtained by applying grease as coating material on the surface of PC steel material as tendon and covering the resultant PC steel material with sheath member such as polyethylene or the like. In this method, before casting of concrete, the above-mentioned unbonding PC steel material is arranged. After hardening of the concrete, the PC steel material is tensioned. When the PC steel material is tensioned, the tension strength is transmitted along the whole length of the PC steel material because the fluid grease exists between the concrete and the PC steel material. Accordingly, metal sheath member used in usual post-tensioning system is no longer necessary, with the result that insertion of the tendon into the sheath member as well as grouting operation for injecting cement milk or the like are no longer required. Therefore, the problem of cost rise which is one disadvantage of usual post-tensioning systems can be solved.

However, the above method has disadvantages of poor bending strength and poor fatigue strength of concrete since the grease as coating material will never be cured, and the tendon will never bond to the concrete.

As a technique for solving the above disadvantage accompanying the method using the above-mentioned unbonding steel material, also proposed is a method that thermo-curing composition in uncured state as coating material is applied on the surface of the PC steel material, and the resultant PC steel is arranged in concrete in the same manner as the case of the above-mentioned unbonding PC steel material. After tensioning the PC steel material, the steel material is heated by means of high-frequency heating or the like to allow the thermo-curing composition applied on the steel material to be cured, causing adhesion between the PC steel material and the concrete. However, in this technique, since the tendon which is being tensioned is heated, the strength of the tendon may be decreased due to the heating, which is very risky. In addition, it is difficult to accurately heat only certain material region in massive concrete structure, which leads the disadvantage that complete adhesion along the whole length of the steel with concrete is impossible.

From the view point of solving these problems, in Japanese Examined Patent Publication No. HEI 8-11791 (1996), is proposed a technique that secures adhesion between concrete and PC tendon while exerting anti-rust and anti-corrosion effects of the PC tendon without causing the above-mentioned problems by applying coating material with controlled curing time (curable coating composition) on surfaces of the PC tendon.

A curable composition used in this technique is based on epoxy resin, blended with potential curing agent such as dihydrazides, diphenyldiaminosulfone, dicyan diamide, imidazole and derivatives thereof, and curing accelerator such as tertiary amine compound if necessary.

Development of such a technique enabled effective exertion of functions of the PC tendon, however, this technique still has a little problem to be solved. Specifically, in the case of a massive concrete structure, since the exothermic temperature after casting concrete exceeds 90° C. and the high temperature is retained for a long time, such a situation occurs that the curable coating composition unintendedly starts curing, and the PC tendon cannot be tensioned after hardening of the concrete.

As a technique that can be used under high exothermic temperature during hardening of concrete, also proposed is a technique that is available at high temperatures by controlling the curing time by applying curable coating composition containing epoxy resin and moisture curing agent on surface of PC tendon (see for example, Japanese Unexamined Patent Publication No. 2000-281967). In this technique, ketimine is used as the moisture curing agent.

The above-mentioned ketimine reacts with moisture to generate curing agent. Industrially produced ketimine is primary amine blocked by ketones at a blocking percentage of about 80 to 90%; hence, it includes about 10 to 20% of remaining active amines. Therefore, in such a curable coating material, since the remaining active amines gradually increase the viscosity, storage stability is not satisfactory. That is, in curable coating composition having insufficient storage stability, the viscosity increases due to reactions occurring before it is applied on PC tendon after production thereof, which may impair usability in coating operation and reduce the life of the product.

The present invention has been completed under the above circumstance, and it is an object of the present invention to provide coating composition for PC tendon, enabling effective tensioning even after hardening of concrete when applied to massive concrete structure, while exhibiting excellent storage stability.

### DISCLOSURE OF THE INVENTION

A coating composition for PC tendon according to the present invention that achieved the above object is a composition to be used for applying on surface of the PC tendon. This composition comprises epoxy resin, multifunctional isocyanate compound, calcium oxide and water. Herein, curing time thereof is adjusted so that tensioning by the PC tendon can be exerted 30 days or later after casting of concrete.

The epoxy resin used in the coating composition according to the present invention preferably has two or more epoxy groups and less than one hydroxyl group on an average in one molecule. Additionally, the water is preferably contained in a ratio of 0.5 to 2.0 by equivalent relative to the isocyanate group.

Advantageously, the composition according to the present invention further comprises water-absorbing polymer as necessary. Such water-absorbing polymer is preferably contained in a content of about 5 to 30% by mass in the composition.

### BEST MODE FOR CARRYING OUT THE INVENTION

In order to realize a coating composition for PC tendon that can achieve the above object, the present inventors studied from various points of view. As a result, the present inventors found that the above object is successively achieved when the curing time is adjusted so that tensioning by the tendon comes into effective 30 days or later after casting of the concrete by defining chemical composition of the above composition, and accomplished the present invention.

An epoxy resin that is a component constituting the coating composition according to the present invention preferably has, but not limited to, two or more epoxy groups on an average in one molecule. Examples of such an epoxy resin may include: polyglycidyl compounds of polyphenol such as 2,2-bis(4-hydroxyphenyl)propane (commonly called “bisphenol A”), bis(4-hydroxyphenyl)methane (commonly called “bisphenol F”), 1,1-bis(4-hydroxyphenyl)ethane (commonly called “bisphenol AD”), 2,2-bis (3,5-dibromo-4-hydroxyphenyl) propane (commonly called “TBA”), hydroquinone and resorcin; polyalcohols such as ethylene glycol and glycerin; and polyglycidyl compounds of multiple carboxylic acids such as phthalic acid.

Among the above epoxy resins, when an epoxy resin having one or more hydroxyl groups in one molecule is used, it is preferred to use anhydride or the like so that the number of hydroxyl groups is less than one. If epoxy resin having one or more hydroxyl groups in one molecule is used, the viscosity becomes significantly large by reaction with curing agent, resulting in reduction of storage stability.

In the coating composition according to the present invention, the curing time of the epoxy resin is adjusted by blending multifunctional isocyanate compound as curing agent and water (water-absorbing polymer as necessary) in an appropriate ratio. Examples of the usable curing agent may include various types of multifunctional isocyanate compounds described in the following (1) to (10).

(1) Aliphatic Polyisocyanates

Ethylene diisocyanate, trimethylene diisocyanate, tetramethylene diisocyanate, hexamethylene diisocyanate, octamethylene diisocyanate, nonamethylene diisocyanate, 2,2-dimethylpentane diisocyanate, 2,2,4-trimethylhexamethylene diisocyanate, decamethylene diisocyanate, buthene diisocyanate, 1,3-butadiene-1,4-diisocyanate, 2,4,4-trimethylhexamethylene diisocyanate, 1,6,11-undeca triisocyanate, 1,3,6-hexamethylene triisocyanate, 1,8-diisocyanate-4-isocyanatemethyloctane, 2,5,7-trimethyl-1,8-diisocyanate-5-isocyanatemethyloctane, bis(isocyanateethyl)carbonate, bis(isocyanateethyl)ether, 1,4-butyleneglycol dipropylether-ω, ω′-diisocyanate, lysine diisocyanate methyl ester, lysine triisocyanate, 2-isocyanateethyl-2,6-diisocyanateethyl-2,6-diisocyanatehex anoate, 2-isocyanatepropyl-2,6-diisocyanatehexanoate, xylene diisocyanate, bis(isocyanateethyl)benzene, bis(isocyanatepropyl) benzene, α, α, α′, α′-tetramethylxylene diisocyanate, bis(isocyanatebutyl)benzene, bis(isocyanatemethyl)naphthalene, bis(isocyanatemethyl)diphenyl ether, bis(isocyanateethyl)phthalate, mesitylene triisocyanate, 2,6-di(isocyanatemethyl)furan, and the like.

(2) Alicyclic Polyisocyanates

Isophorone diisocyanate, bis(isocyanatemethyl)cyclohexane, 4,4′-dicyclohexylmethane-diisocyanate, cyclohexane diisocyanate, methylcyclohexane diisocyanate, dicyclohexyldimethylmethane diisocyanate, 2,2-dimethyldicyclohexylmethane diisocyanate, bis(4-isocyanate-n-butylidene)pentaerythritol, dimer acid diisocyanate, 2-isocyanatemethyl-3-(3-isocyanatepropyl)-5-isocyanatemethy 1-bicyclo[2,2,1]heptane, 2-isocyanatemethyl-3-(3-isocyanatepropyl)-6-isocyanatemethy 1-bicyclo[2,2,1]heptane, 2-isocyanatemethyl-2-(3-isocyanatepropyl)-5-isocyanatemethy 1-bicyclo[2,1,1]heptane, 2-isocyanatemethyl-2-(3-isocyanatepropyl)-6-isocyanatemethy 1-bicyclo[2,1,1]heptane, 2-isocyanatemethyl-3-(3-isocyanatepropyl)-6-(2-isocyanateet hyl-bicyclo[2,2,1]heptane, 2-isocyanatemethyl-3-(3-isocyanatepropyl)-6-(2-isocyanateet hyl)-bicyclo[2,1,1]heptane, 2-isocyanatemethyl-2-(3-isocyanatepropyl)-5-(2-isocyanateet hyl)-bicyclo[2,1,1]heptane, 2-isocyanatemethyl-2-(3-isocyanatepropyl)-6-(2-isocyanateet hyl)-bicyclo[2,1,1]heptane, 2-isocyanatemethyl-2-(3-isocyanatepropyl)-6-(2-isocyanateet hyl)-bicyclo[2,2,1]heptane, 2-isocyanatemethyl-3-(3-isocyanatepropyl)-6-(2-isocyanateet hyl)-bicyclo[2,2,1]heptane, 2,5-bisisocyanatemethyl norbornane, 2,6-bisisocyanatemethyl norbornane, and the like.

(3) Aromatic Polyisocyanates

Phenylene diisocyanate, tolylene diisocyanate, ethylphenylene diisocyanate, isopropylenephenylene diisocyanate, dimethylphenylene diisocyanate, diethylphenylene diisocyanate, diisopropylphenylene diisocyanate, trimethylbenzene triisocyanate, benzene triisocyanate, naphthalene diisocyanate, methylnaphthalene diisocyanate, biphenyl diisocyanate, 4,4′-diphenylmethane diisocyanate, 3,3′-dimethyldiphenylmethane-4,4′-diisocyanate, dibenzyl-4,4′-diisocyanate, bis(isocyanatephenyl)ethylene, 3,3′-dimethoxybiphenyl-4,4′-diisocyanate, triphenylmethane triisocyanate, polymeric MDI “COSMONATE M-200” (trade name) available from Mitsui Takeda Chemicals, Inc., naphthalene triisocyanate, diphenylmethane-2,4,4′-triisocyanate, 3-methyldiphenylmethane-4,6,4′-triisocyanate, 4-methyl-diphenylmethane-3,5,2′,4′,6′-pentaisocyanate, phenylisocyanatemethyl isocyanate, phenylisocyanateethyl ethylisocyanate, tetrahydronaphthylene diisocyanate, hexahydrobenzene diisocyanate, hexahydrodiphenylmethane-4,4′-diisocyanate, diphenylether diisocyanate, ethyleneglycol diphenylether dilsocyanate, 1,3-propyleneglycol diphenylether diisocyanate, benzophenone diisocyanate, diethyleneglycol diphenylether diisocyanate, dibenzofuran diisocyanate, carbazole diisocyanate, ethylcarbazole diisocyanate, dichlorocarbazole diisocyanate, and the like.

(4) Sulfur-Containing Aliphatic Isocyanates

Thiodiethyl diisocyanate, thiopropyl diisocyanate, thiodihexyl diisocyanate, dimethylsulfone diisocyanate, dithiodimethyl diisocyanate, dithiodiethyl diisocyanate, dithiopropyl diisocyanate, dicyclohexylsulfide-4,4′-diisocyanate, and the like.

(5) Aromatic Sulfide Type Isocyanates

Diphenylsulfide-2,4′-diisocyanate, diphenylsulfide-4,4′-diisocyanate, 3,3′,4,4′-diisocyanatebenzylthioether, bis(4-isocyanatemethylbenzene) sulfide, 4,4′-methoxybenzenethioglycol-3,3′-diisocyanate, and the like.

(6) Aliphatic Disulfide Type Isocyanates

Diphenyldisulfide-4,4′-diisocyanate, 2,2′-dimethyldiphenyldisulfide-5,5′-diisocyanate, 3,3′-dimethyldiphenyldisulfide-5,5′-diisocyanate, 3,3′-dimethyldiphenyldisulfide-6,6′-diisocyanate, 4,4′-dimethyldiphenyldisulfide-5,5-diisocyanate, 3,3′-dimethoxyphenyldisulfide-4,4′-diisocyanate, 4,4′-dimethoxydiphenyldisulifide-3,3′-diisocyanate, and the like.

(7) Aromatic Sulfone Type Isocyanates

Diphenylsulfone-4,4-diisocyanate, diphenylsulfone-3,3′-diisocyanate, benzidinesulfone-4,4′-diisocyanate, diphenylmethanesulfone-4,4′-diisocyanate, 4-methyldiphenylmethanesulfone-2,4′-diisocyanate, 4,4′-dimethoxydiphenylsulfone-3,3′-diisocyanate, 3,3′-dimethoxy-4,4′-diisocyanate dibenzylsulfone, 4,4′-dimethyldiphenylsulfone-3,3′-diisocyanate, 4,4′-di-tert-butyldiphenylsulfone-3,3′-diisocyanate, 4,4′-methoxybenzeneethylenedisulfone-3,3′-diisocyanate, 4,4′-dichlorodiphenylsulfone-3,3′-diisocyanate, and the like.

(8) Sulfonic Acid Ester Type Isocyanates

4-methyl-3-isocyanatebenzenesulfonyl-4′-isocyanatephenol ester, 4-methoxy-3-isocyanatebenzenesulfonyl-4′-isocyanatephenol ester, and the like.

(9) Aromatic Sulfonic Acid Amide Type Isocyanates

4,4-dimethylbenzenesulfonyl-ethylenediamine-4,4′-diisocyanate, 4,4-dimethoxybenzenesulfonyl-ethylenediamine-3,3′-diisocyanate, 4-methyl-3-isocyanatebenzenesulfonylanilide-4-methyl-3′-iso cyanate, and the like.

(10) Sulfur-Containing Heterocyclic Compounds

Thiophene-2,5-diisocyanate, thiophene-2,5-diisocyanatemethyl, 1,4-dithiane-2,5-diisocyanate, 1,4-dithiane-2,5-diisocyanatemethyl, and the like.

Alkyl-substituted compounds, alkoxy-substituted compounds, nitro-substituted compounds, blend polymer type modified compounds with polyalcohol, carbodiimide-modified compounds, urea-modified compounds, buret-modified compounds, and products of dimerization or trimerization reactions of the above compounds can be used. Multifunctional isocyanate compounds other than the above compounds may be used. As the multifunctional isocyanate compound of the present invention, a kind of these multifunctional isocyanate compounds or the mixture of more than one kind of these compounds can be used.

Among these compounds, from the view point of availability of multifunctional isocyanate compounds, tolylene diisocyanate, 4,4′-diphenylmethane diisocyanate, hexamethylene diisocyanate, isophorone diisocyanate, 2,5-bisisocyanatemethyl norbornane, α, α, α′, α′-tetramethylxylylene diisocyanate, 2,6-bisdiisocyanatemethylnorbornane, 4,4′-dicyclohexylmethanediisocyanate, trimethylhexamethylene diisocyanate and derivatives thereof can be preferably used.

From the view point of curing of the resultant coating composition, hexamethylene diisocyanate, isophorone diisocyanate, 2,5-bisisocyanatemethyl norbornane, α, α, α′, α′-tetramethylxylylene diisocyanate, 2,6-bisisocyanatemethylnorbornane, 4,4′-dicyclohexylmethanediisocyanate, trimethylhexamethylene diisocyanate and derivatives thereof can be especially preferably used.

From the view point of storage stability of the coating composition, 4,4′-dicyclohexylmethanediisocyanate, isophorone diisocyanate, α, α, α′, α′-tetramethylxylylene diisocyanate can be preferably used.

Curing property (curing time) of epoxy resin can be adjusted depending on the blending amount of the above multifunctional isocyanate compound. In the present invention, it is preferred to blend so that the ratio of epoxy group/isocyanate group (ratio by equivalent) falls within the range of 1.000/0.017 to 1.000/0.17. When the epoxy group/isocyanate group (ratio by equivalent) is smaller than 1.000/0.017, curing is too slow. On the other hand, when it is larger than 1.000/0.17, curing is too fast. The above range is more preferably about 1.000/0.034 to 1/0.154.

The coating composition according to the present invention comprises calcium oxide. Calcium oxide is useful for preventing occurrence of foaming by trapping carbon dioxide gas generated in the system. In order to bring such an action into effective, the blending amount of calcium oxide is preferably at least approximately equal to the amount (ratio by equivalent) of isocyanate group.

Water in the coating composition of the present invention reacts with the multifunctional isocyanate compound to generate primary amine which reacts with the epoxy resin to form cross-linked structure, whereby toughness is afforded. In order to bring such an action effective, the adding amount of water (in total considering water originated from raw material and generated during production processes) is preferably adjusted to fall within the range of 0.5 to 2.0 (ratio by equivalent) relative to the isocyanate group. When the above equivalent ratio (water/isocyanate group) is smaller than 0.5, generation of primary amine is reduced. On the other hand, when it is larger than 2.0, the remaining water will deteriorate physical properties.

The coating composition according to the present invention advantageously comprises water-absorbing polymer as necessary, and this water-absorbing polymer is useful for keeping the water content in the composition constant. In order to bring such an action effective, the content of water-absorbing polymer is preferably about 5 to 30% by mass in the composition. A content of the water-absorbing polymer of less than 5% by mass will reduce the water retention in the system, while a content exceeding 30% by mass will deteriorate physical properties in the system. Examples of the water-absorbing polymer which can be used in the present invention may include acrylic acid polymers partially cross-linked with sodium salt, “AQUALIC CA ML-20”, “AQUALIC K4”, “AQUALIC H2”, “AQUALIC H3” and the like (trade names, available from Nippon Shokubai Co., Ltd.).

The coating composition according to the present invention may be used together with calcium carbonate, talc, silica, coloring pigment or the like that are commonly used as fillers for paint or adhesive as necessary. These fillers are useful for adjusting viscosity and thixotropic property. Organic solvents not having an active hydrogen, dispersing agents, antifoaming agents, or the like can also be used for adjusting the viscosity.

As a method for producing the coating composition according to the present invention, for example, the following method can be given without any limitation. First, epoxy resin having two or more epoxy groups and having less than one hydroxyl group on an average in one molecule, and multifunctional isocyanate compound as curing agent are blended in a ratio of 1.000/0.017 to 1.000/0.170 (ratio by equivalent). Then, calcium oxide, water, and as necessary, water-absorbing polymer and filler as described above are added and mixed by stirring. After completion of mixing, deforming is conducted in vacuum to obtain a coating material.

When used in a post-tensioning system, the coating composition according to the present invention is applied on the surface of PC tendon, and the resultant tendon is covered with sheath member consisting of resin such as polyethylene with irregularities formed on its surface and inner face. It takes about two weeks after casting of concrete to acquire a predetermined strength, and may take about another two weeks until tensioning depending on the construction schedule. Therefore, the curing time of the coating composition should be adjusted so that tensioning is allowed for at least 30 days after casting of the concrete. Furthermore, it is preferably adjusted to cure in one to two years after tensioning of the PC tendon.

In order to exert the effect of the coating composition according to the present invention effectively, the coating thickness of the coating composition is preferably 20 μm or more. This is because when the coating thickness is less than 20 μm, the breaking off at the boundary of the PC steel material and the concrete or the sheath member is not sufficient at the time of tensioning, so that the friction coefficient is large. As a coating method, any method can be applied without limitation as far as uniform coating on the surface of the PC tendon can be realized. An example thereof may include a coating method capable of uniformly coating with an intended amount of resin, wherein a steel material is allowed to pass through a resin box filled with resin, and excess resin is removed through a hole which is provided at an outlet of the resin box and has the same diameter as that of the steel material after coating.

### EXAMPLES

In the following, the present invention will be described in more detail by way of examples. The following examples are not intended to limit the present invention, and any modification of design from the above or below description is encompassed in a technical scope of the present invention.

### Production Example 1

Epoxy resin R140 available from Mitsui Chemicals, Inc. (72.30 g), calcium oxide (13.77 g), calcium carbonate (10.21 g) and AEROSIL (1.38 g) were introduced into a mixer, and mixed for 30 minutes under stirring. The water content was then measured. The water content was 0.02%.

Next, isophorone diisocyanate (IPDI) (2.17 g) was added and mixed for 10 minutes under stirring. Water (0.17 g) wad then added and mixed for 10 minutes under stirring. Then, defoaming treatment was conducted under reduced pressures to obtain a coating composition.

The obtained coating composition was applied on a PC steel material (steel rod) having a diameter of 12.7 mm in a thickness of 0.5 to 1.0 mm. Then it was covered with a sheath member consisting of polyethylene with irregularities formed on its surface and inner face, and buried in concrete. After 30 days, the coating composition was removed from the concrete, and the viscosity of the coating composition was measured (provided that the measurement concerning the coating composition of Production Example 1 to 12 was conducted only when the coating composition was soft enough to allow measurement of viscosity), and after 1.5 years, the coating composition was removed again from the concrete, and the degree of hardness of the coating composition was measured with a type-D durometer. In addition, the coating composition was put into a glass airtight container and stored in a temperature-controlled room at 23° C., and storage stability was evaluated from change in viscosity with time.

The maximum exothermic temperature during concrete placing was 95° C. Viscosity after 30 days and viscosity in evaluation of storage stability were measured by a Brookfield viscometer and an E-type viscometer, respectively.

### Production Example 2

Epoxy resin R140, available from Mitsui Chemicals, Inc. (72.17 g), calcium oxide (13.74 g), calcium carbonate (10.20 g) and AEROSIL (1.37 g) were put into a mixer, and mixed for 30 minutes under stirring. The water content was then measured. The water content was 0.02%.

Next, IPDI (2.17 g) was added and mixed for 10 minutes under stirring. Water (0.35 g) was then added and mixed for 10 minutes under stirring. Then, defoaming treatment was conducted under reduced pressures to obtain a coating composition. The obtained coating composition was evaluated for viscosity, degree of hardness and storage stability in similar manner as described in Production Example 1.

### Production Example 3

Epoxy resin R140 available from Mitsui Chemicals, Inc. (72.05 g), calcium oxide (13.71 g), calcium carbonate (10.17 g) and AEROSIL (1.37 g) were put into a mixer, and mixed for 30 minutes under stirring. Water content was then measured. The water content was 0.02%.

Next, IPDI (2.17 g) was added and mixed for 10 minutes under stirring. Water (0.53 g) was then added and mixed for 10 minutes under stirring. Then, defoaming treatment was conducted under reduced pressures to obtain a coating composition. The obtained coating composition was evaluated for viscosity, degree of hardness and storage stability in similar manner as described in Production Example 1.

### Production Example 4

Epoxy resin R140 available from Mitsui Chemicals, Inc. (70.41 g), calcium oxide (13.41 g), calcium carbonate (9.94 g) and AEROSIL (1.34 g) were put into a mixer, and mixed for 30 minutes under stirring. Water content was then measured. The water content was 0.02%.

Next, IPDI (4.22 g) was added and mixed for 10 minutes under stirring. Water (0.68 g) was then added and mixed for 10 minutes under stirring. Then, defoaming treatment was conducted under reduced pressures to obtain a coating composition. The obtained coating composition was evaluated for viscosity, degree of hardness and storage stability in similar manner as described in Production Example 1.

### Production Example 5

Epoxy resin R140 available from Mitsui Chemicals, Inc. (68.72 g), calcium oxide (13.08 g), talc (9.69 g) and AEROSIL (1.31 g) were put into a mixer, and mixed for 30 minutes under stirring. The water content was then measured. The water content was 0.02%.

Next, IPDI (6.19 g) was added and mixed for 10 minutes under stirring. Water (1.01 g) was then added and mixed for 10 minutes under stirring. Then, defoaming treatment was conducted under reduced pressures to obtain a coating composition. The obtained coating composition was evaluated for viscosity, degree of hardness and storage stability in similar manner as described in Production Example 1.

### Production Example 6

Epoxy resin R140 available from Mitsui Chemicals, Inc. (68.87 g), calcium oxide (13.11 g), calcium carbonate (9.72 g) and AEROSIL (1.31 g) were put into a mixer, and mixed for 30 minutes under stirring. The water content was then measured. The water content was 0.02%.

Next, a water-absorbing polymer (AQUALIC CA ML-20) (4.76 g) and water (0.16 g) were added, and mixed for 10 minutes under stirring. IPDI (2.07 g) was then added, and mixed for 10 minutes under stirring. Then, defoaming treatment was conducted under reduced pressures to obtain a coating composition. The obtained coating composition was evaluated for viscosity, degree of hardness and storage stability in similar manner as described in Production Example 1.

### Production Example 7

Epoxy resin R140 available from Mitsui Chemicals, Inc. (69.76 g), calcium oxide (13.09 g), calcium carbonate (9.71 g) and AEROSIL (1.31 g) were put into a mixer, and mixed for 30 minutes under stirring. The water content was then measured. The water content was 0.02%.

Next, water-absorbing polymer (AQUALIC CA ML-20) (4.75 g) and water (0.32 g) were added, and mixed for 10 minutes under stirring. IPDI (2.06 g) was then added and mixed for 10 minutes under stirring. Then, defoaming treatment was conducted under reduced pressures to obtain a coating composition. The obtained coating composition was evaluated for viscosity, degree of hardness and storage stability in similar manner as described in Production Example 1.

### Production Example 8

Epoxy resin R140 available from Mitsui Chemicals, Inc. (63.83 g), calcium oxide (12.16 g), calcium carbonate (9.01 g) and AEROSIL (1.22 g) were put into a mixer, and mixed for 30 minutes under stirring. The water content was then measured. The water content was 0.02%.

Next, water-absorbing polymer (AQUALIC CA ML-20) (9.09 g) and water (0.92 g) were added, and mixed for 10 minutes under stirring. IPDI (3.77 g) was then added and mixed for 10 minutes under stirring. Then, defoaming treatment was conducted under reduced pressures to obtain a coating composition. The obtained coating composition was evaluated for viscosity, degree of hardness and storage stability in similar manner as described in Production Example 1.

### Production Example 9

Epoxy resin R140 available from Mitsui Chemicals, Inc. (56.77 g), calcium oxide (10.81 g), calcium carbonate (8.02 g) and AEROSIL (1.08 g) were put into a mixer, and mixed for 30 minutes under stirring. The water content was then measured. The water content was 0.02%.

Next, water-absorbing polymer (AQUALIC CA ML-20) (16.67 g) and water (1.63 g) were added, and mixed for 10 minutes under stirring. IPDI (5.02 g) was then added and mixed for 10 minutes under stirring, further water (1.63 g) was added, and mixed for 10 minutes under stirring. Then, defoaming treatment was conducted under reduced pressures to obtain a coating composition. The obtained coating composition was evaluated for viscosity, degree of hardness and storage stability in similar manner as described in Production Example 1.

### Production Example 10

Epoxy resin R140 available from Mitsui Chemicals, Inc. (72.42 g), IPDI (2.17 g), calcium oxide (13.80 g), calcium carbonate (10.23 g) and AEROSIL (1.38 g) were put into a mixer, and mixed for 30 minutes under stirring. The mixture was subjected to defoaming treatment under reduced pressures to obtain a coating composition.

The obtained coating composition was evaluated for viscosity, degree of hardness and storage stability in similar manner as described in Production Example 1.

### Production Example 11

Epoxy resin R140 available from Mitsui Chemicals, Inc. (56.92 g), benzyl alcohol (6.32 g), dicyan diamide (DICY) (4.43 g), 2,4,6-tris (dimethylaminomethyl)phenol (TAP) (0.08 g), talc (31.62 g) and AEROSIL (0.63 g) were put into a mixer, and mixed for 30 minutes under stirring. The mixture was subjected to defoaming treatment under reduced pressures to obtain a coating composition. The obtained coating composition was evaluated for viscosity, degree of hardness and storage stability in similar manner as described in Production Example 1.

### Production Example 12

Epoxy resin R140 available from Mitsui Chemicals, Inc. (59.88 g), ketimine [“Epicure H-3” (trade name) available from Japan Epoxy Resins Co., Ltd.] (5.99 g), calcium carbonate (29.94 g) and benzyl alcohol (4.19 g) were put into a mixer, and mixed for 30 minutes under stirring. The mixture was subjected to defoaming treatment under reduced pressures to obtain a coating composition. The water content at this time was 0.02%. The obtained coating composition was evaluated for viscosity, degree of hardness and storage stability in similar manner as described in Production Example 1.

Respective blending ratios of the coating compositions described above are shown in Tables 1 and 2 below. Viscosity, degree of hardness and storage stability of each coating composition are shown in Table 3 below.

TABLE 1

| | Production Example | | | | |
|---|---|---|---|---|---|
| Blending amount | 1 | 2 | 3 | 4 | 5 |
| Epoxy resin (R140) (g) | 72.30 | 72.17 | 72.05 | 70.41 | 68.72 |
| IPDI (g) | 2.17 | 2.17 | 2.17 | 4.22 | 6.19 |
| Calcium oxide (g) | 13.77 | 13.74 | 13.71 | 13.41 | 13.08 |
| Calcium carbonate (g) | 10.21 | 10.20 | 10.17 | 9.94 | — |
| Talc (g) | — | — | — | — | 9.69 |
| AEROSIL (g) | 1.38 | 1.37 | 1.37 | 1.34 | 1.31 |
| DICY (g) | — | — | — | — | — |
| TAP (g) | — | — | — | — | — |
| Ketimine (g) | — | — | — | — | — |
| Benzyl alcohol (g) | — | — | — | — | — |
| Water (g) | 0.17 | 0.35 | 0.53 | 0.68 | 1.01 |
| Ratio by equivalent | 1.000/ | 1.000/ | 1.000/ | 1.000/ | 1.000/ |
| (isocyanate/water) | 0.500 | 1.000 | 1.500 | 1.000 | 1.000 |

TABLE 2

| | Production Example | | | | | | |
|---|---|---|---|---|---|---|---|
| Blending amount | 6 | 7 | 8 | 9 | 10 | 11 | 12 |
| Epoxy resin (R140) (g) | 68.87 | 68.76 | 68.83 | 56.77 | 72.42 | 56.92 | 59.88 |
| IPDI (g) | 2.07 | 2.06 | 3.77 | 5.02 | 2.17 | — | — |
| Calcium oxide (g) | 13.11 | 13.09 | 12.16 | 10.81 | 13.80 | — | — |
| Calcium carbonate (g) | 9.72 | 9.71 | 9.01 | 8.02 | 10.23 | — | — |
| Talc (g) | — | — | — | — | — | 31.62 | 29.94 |
| AEROSIL (g) | 1.31 | 1.31 | 1.22 | 1.08 | 1.38 | 0.63 | — |
| Water-absorbing polymer (g) | 4.76 | 4.75 | 9.09 | 16.67 | — | — | — |
| DICY (g) | — | — | — | — | — | 4.43 | — |
| TAP (g) | — | — | — | — | — | 0.08 | — |
| Ketimine (g) | — | — | — | — | — | — | 5.99 |
| Benzyl alcohol (g) | — | — | — | — | — | 6.32 | 4.19 |
| Water (g) | 0.16 | 0.32 | 0.92 | 1.63 | 0 | 0 | 0 |
| Ratio by equivalent | 1.000/ | 1.000/ | 1.000/ | 1.000/ | 1.000/ | — | — |
| (isocyanate/water) | 0.500 | 1.000 | 1.500 | 2.000 | 1.0 | | |

TABLE 3

| | | | Storage stability | |
|---|---|---|---|---|
| | | | Viscosity | |
| | | | directly | |
| | | Hardness after | after | |
| | Viscosity after | 1.5 years | production | Viscosity after |
| Production | 30 days | (Type-D | (Pa · s/ | one month |
| Example | (Pa · s/23° C.) | durometer) | 23° C.) | (Pa · s/23° C.) |
| 1 | 610 | 46 | 65 | 1.03 |
| 2 | 650 | 43 | 65 | 1.03 |
| 3 | 640 | 45 | 60 | 1.02 |
| 4 | 680 | 42 | 66 | 1.03 |
| 5 | 590 | 45 | 65 | 1.03 |
| 6 | 680 | 46 | 70 | 1.02 |
| 7 | 670 | 45 | 69 | 1.03 |
| 8 | 710 | 47 | 75 | 1.03 |
| 9 | 730 | 48 | 78 | 1.01 |
| 10 | 530 | 0 | 63 | 1.02 |
| 11 | incapable | 52 | 70 | 1.03 |
| | measurement | | | |
| 12 | 2600 | 48 | 62 | 2.15 |

From these results, we can discuss as follows. First, the coating compositions produced in Production Examples 1 to 9 satisfy all the requirements defined in the present invention. Therefore, it is found that tensioning was possible 30 days or later after casting of the concrete, the composition could be cured after 1.5 years and had excellent storage stability with low thickening factor after one month.

To the contrary, the coating compositions produced in Production Examples 10 to 12 do not satisfy either of the requirements defined in the present invention, so that they were inferior in either characteristic.

The coating material produced in Production Example 10 was superior in storage stability, and tensioning was possible after 30 days. However, since generation of primary amine was insufficient, curing was insufficient after 1.5 years. The coating material produced in Production Example 11 was superior in storage stability. However, since the curing starts, tensioning after 30 days or later could not be realized. The coating material produced in Production Example 12 was inferior in storage stability with high magnification of viscosity after 30 days because the remaining active amine caused curing even though tensioning after 30 days or later was possible.

### INDUSTRIAL APPLICABILITY

The present invention constituted as described above makes it possible to realize coating composition for PC tendon, by which tensioning 30 days or later after casting of concrete is possible. The coating composition can be cured at a predetermined time after tensioning and has excellent storage stability. By using the coating composition according to the present invention and bringing out its such characteristics described above, tensioning is possible when exothermic temperature after casting of concrete exceeds 90° C. in the case of a massive concrete structure, and the tendon with anti-rust and anti-corrosion effect can be provided and sufficient adhesion between the concrete and the PC tendon can be realized. Furthermore, since the coating composition has excellent storage stability, it is useful because deterioration of operability due to thickening during use can be avoided.

1. A coating composition for a tendon for prestressed concrete;
wherein being applied on surface of the tendon;
comprising epoxy resin, multifunctional isocyanate compound, calcium oxide and water; and
curing time thereof is adjusted so that tensioning by the tendon can be exerted 30 days or later after casting of the concrete.

2. The coating composition for a tendon for prestressed concrete according to claim 1, wherein said epoxy resin has two or more epoxy groups and less than one hydroxyl group by an average in one molecule.

3. The coating composition for a tendon for prestressed concrete according to claim 1, wherein said water is contained in a ratio of 0.5 to 2.0 by equivalent relative to the isocyanate group.

4. The coating composition for a tendon for prestressed concrete according to claim 2, wherein said water is contained in a ratio of 0.5 to 2.0 by equivalent relative to the isocyanate group.

5. The coating composition for a tendon for prestressed concrete according to claim 1, further comprising water-absorbing polymer.

6. The coating composition for a tendon for prestressed concrete according to claim 5, wherein said water-absorbing polymer is contained in a ratio of 5 to 30% by mass with respect to the composition.

7. The coating composition for a tendon for prestressed concrete according to claim 2, further comprising water-absorbing polymer.

8. The coating composition for a tendon for prestressed concrete according to claim 3, further comprising water-absorbing polymer.

9. The coating composition for a tendon for prestressed concrete according to claim 4, further comprising water-absorbing polymer.

10. The coating composition for a tendon for prestressed concrete according to claim 7, wherein said water-absorbing polymer is contained in a ratio of 5 to 30% by mass with respect to the composition.

11. The coating composition for a tendon for prestressed concrete according to claim 8, wherein said water-absorbing polymer is contained in a ratio of 5 to 30% by mass with respect to the composition.

12. The coating composition for a tendon for prestressed concrete according to claim 9, wherein said water-absorbing polymer is contained in a ratio of 5 to 30% by mass with respect to the composition.
